(19) United States
(12) Patent Application Publication
(10) Pub. No.: US 2025/0317672 A1
(43) Pub. Date: Oct. 9, 2025

(54) GENERATIVE ARTIFICIAL INTELLIGENCE-ASSISTED TELEMETRY INSTRUMENTATION

(71) Applicant: Cisco Technology, Inc., San Jose, CA (US)

(72) Inventors: Tom Thekkel Jose, Milpitas, CA (US); Jaideep Padhye, San Jose, CA (US); Najuka Prakash Sankhe, San Jose, CA (US); Vishweshwar Ghanakota, Cardiff, CA (US)

(73) Assignee: Cisco Technology, Inc., San Jose, CA (US)

(21) Appl. No.: 18/627,578

(22) Filed: Apr. 5, 2024

(51) Int. Cl. H04Q 9/00; G06F 40/47

(52) U.S. Cl. CPC H04Q 9/00; G06F 40/47

(57) ABSTRACT

In one implementation, a device may maintain a catalog of attributes that can be collected via a monitoring agent from an application. The device may receive, from a user interface, a prompt for input to a language model that requests collection of a particular type of data from the application. The device may generate, using the language model, a response to the prompt that includes a recommended configuration for the monitoring agent to collect the particular type of data from the application. The device may provide the response to the user interface for display.

### TECHNICAL FIELD

The present disclosure relates generally to generative artificial intelligence (AI)-assisted telemetry instrumentation.

### BACKGROUND

Telemetry instrumentation is central to monitoring application performance, diagnosing issues, and understanding user interactions. Traditional approaches to telemetry instrumentation involve manually coding probes or markers into an application to collect data such as logs, metrics, and traces. This data is essential for observability platforms to provide insights into application/process health, performance bottlenecks, and user experience, among other insights.

Conventional observability frameworks/standards have largely standardized the collection and exportation of telemetry data across different languages and platforms, offering automatic instrumentation capabilities that reduce the manual effort required and/or the accompanying errors of manual efforts. Yet, even with these standards, the challenge of incorporating particular types of metrics (e.g., some non-standard application or process metrics associated with a business impact) into telemetry data persists. Consequently, the standard attributes collected by automatic instrumentation simple do not encompass these custom attributes that are important to understand particular outcomes and behaviors in the application.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example observability intelligence platform;

FIG. 4 illustrates an example of an architecture for automated custom telemetry instrumentation utilizable with generative AI-assisted telemetry instrumentation;

FIG. 5 illustrates an example of a dynamic data collector extension utilizable in generative AI-assisted telemetry instrumentation;

FIG. 6 illustrates an example of an architecture for generative AI-assisted telemetry instrumentation; and

FIG. 7 illustrates an example simplified procedure for generative AI-assisted telemetry instrumentation, in accordance with one or more implementations described herein.

### DESCRIPTION OF EXAMPLE IMPLEMENTATIONS

### Overview

According to one or more implementations of the disclosure, a device may maintain a catalog of attributes that can be collected via a monitoring agent from an application. The device may receive, from a user interface, a prompt for input to a language model that requests collection of a particular type of data from the application. The device may generate, using the language model, a response to the prompt that includes a recommended configuration for the monitoring agent to collect the particular type of data from the application. The device may provide the response to the user interface for display.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

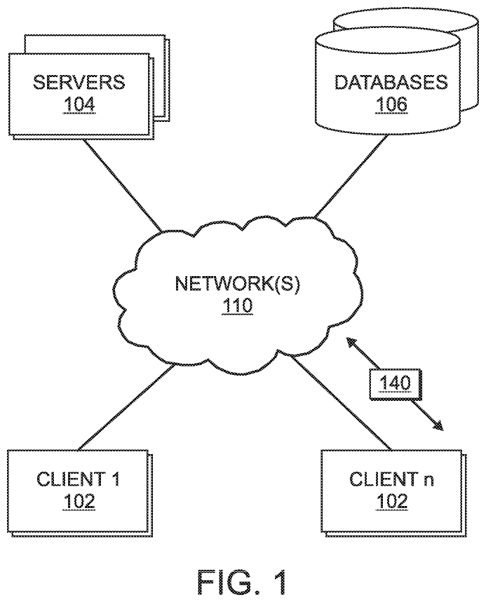

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

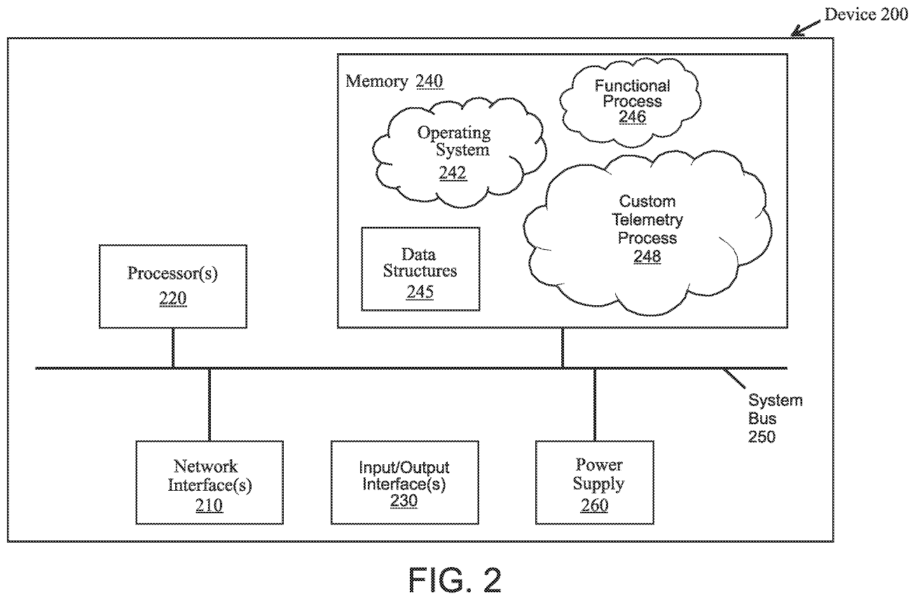

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise a one or more functional processes (e.g., functional processes 246), and on certain devices, a custom telemetry process 248, as described herein. Notably, functional processes 246, when executed by processor 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, custom telemetry process 248 may include computer executable instructions that, when executed by processor 220, cause device 200 to perform the techniques described herein. To do so, in some implementations, custom telemetry process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, custom telemetry process 248 may employ one or more supervised, unsupervised, or semi-supervised machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that custom telemetry process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, custom telemetry process 248 may also include, or otherwise use, one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of configuring an observability platform to perform certain application analytics, custom telemetry process 248 may use a generative model to generate configurations based on a conversational input from a user (e.g., voice, text, etc.). Example generative approaches can include, but are not limited to, generative adversarial networks (GANs), large language models (LLMs), other transformer models, and the like.

The performance of a machine learning model can be evaluated in a number of ways based on the number of true positives, false positives, true negatives, and/or false negatives of the model. For example, consider the case of a model that predicts whether the QoS of a path will satisfy the service level agreement (SLA) of the traffic on that path. In such a case, the false positives of the model may refer to the number of times the model incorrectly predicted that the QoS of a particular network path will not satisfy the SLA of the traffic on that path. Conversely, the false negatives of the model may refer to the number of times the model incorrectly predicted that the QoS of the path would be acceptable. True negatives and positives may refer to the number of times the model correctly predicted acceptable path performance or an SLA violation, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

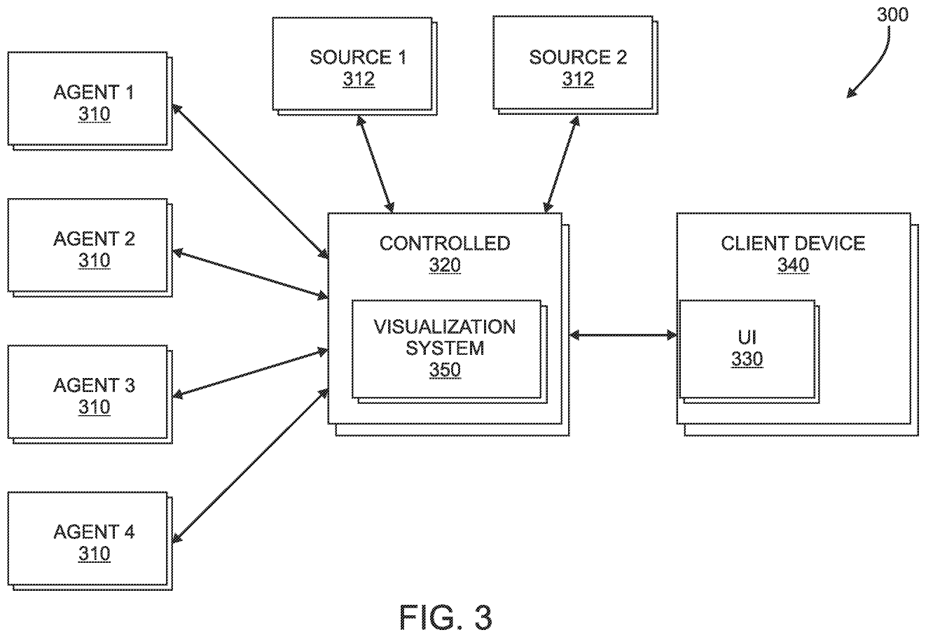

FIG. 3 is a block diagram of an example observability intelligence platform 300 that can implement one or more aspects of the techniques herein. The observability intelligence platform is a system that monitors and collects metrics of performance data for a network and/or application environment being monitored. At the simplest structure, the observability intelligence platform includes one or more agents (e.g., agents 310), one or more sources (e.g., sources 312), and one or more servers/controllers (e.g., controller 320). Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller 320 as directed. Note that while FIG. 3 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe packets may be configured to be sent from agents to travel through the Internet, go through many different networks, and so on, such that the monitoring solution gathers all of the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page—i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controller 320 is the central processing and administration server for the observability intelligence platform. The controller 320 may serve a user interface 330 (denoted UI in FIG. 3), such as a browser-based UI, that is the primary interface for monitoring, analyzing, and troubleshooting the monitored environment. Specifically, the controller 320 can receive data from agents 310, sources 312 (and/or other coordinator devices), associate portions of data (e.g., topology, transaction end-to-end paths and/or metrics, etc.), communicate with agents to configure collection of the data (e.g., the instrumentation/tests to execute), and provide performance data and reporting through user interface 330. User interface 330 may be viewed as a web-based interface viewable by a client device 340. In some implementations, a client device 340 can directly communicate with controller 320 to view an interface for monitoring data. The controller 320 can include a visualization system 350 for displaying the reports and dashboards related to the disclosed technology. In some implementations, the visualization system 350 can be implemented in a separate machine (e.g., a server) different from the one hosting the controller 320.

Notably, in an illustrative Software as a Service (SaaS) implementation, an instance of controller 320 may be hosted remotely by a provider of the observability intelligence platform 300. In an illustrative on-premises (On-Prem) implementation, a controller 320 may be installed locally and self-administered.

The controllers 320 receive data from the agents 310 (e.g., Agents 1-4) and/or sources 312 deployed to monitor networks, applications, databases and database servers, servers, and end user clients for the monitored environment. Any of the agents 310 can be implemented as different types of agents with specific monitoring duties. For example, application agents may be installed on each server that hosts applications to be monitored. Instrumenting an agent adds an application agent into the runtime process of the application. Further, the controllers 320 can receive data from sources 312 (e.g., sources 1-2). Any of the sources can be implemented to provide various types of observability data that can include information, metrics, telemetry data, business data, network data, etc.

Database agents, for example, may be software (e.g., a Java program) installed on a machine that has network access to the monitored databases and the controller. Standalone machine agents, on the other hand, may be standalone programs (e.g., standalone Java programs) that collect hardware-related performance statistics from the servers (or other suitable devices) in the monitored environment. The standalone machine agents can be deployed on machines that host application servers, database servers, messaging servers, Web servers, etc. Furthermore, end user monitoring (EUM) may be performed using browser agents and mobile agents to provide performance information from the point of view of the client, such as a web browser or a mobile native application. Through EUM, web use, mobile use, or combinations thereof (e.g., by real users or synthetic agents) can be monitored based on the monitoring needs.

Note that monitoring through browser agents and mobile agents are generally unlike monitoring through application agents, database agents, and standalone machine agents that are on the server. In particular, browser agents may generally be implemented as small files using web-based technologies, such as JavaScript agents injected into each instrumented web page (e.g., as close to the top as possible) as the web page is served and are configured to collect data. Once the web page has completed loading, the collected data may be bundled into a beacon and sent to an EUM process/cloud for processing and made ready for retrieval by the controller. Browser real user monitoring (Browser RUM) provides insights into the performance of a web application from the point of view of a real or synthetic end user. For example, Browser RUM can determine how specific Ajax or iframe calls are slowing down page load time and how server performance impact end user experience in aggregate or in individual cases. A mobile agent, on the other hand, may be a small piece of highly performant code that gets added to the source of the mobile application. Mobile RUM provides information on the native mobile application (e.g., iOS or Android applications) as the end users actually use the mobile application. Mobile RUM provides visibility into the functioning of the mobile application itself and the mobile application's interaction with the network used and any server-side applications with which the mobile application communicates.

Note further that in certain implementations, in the application intelligence model, a transaction represents a particular service provided by the monitored environment. For example, in an e-commerce application, particular real-world services can include a user logging in, searching for items, or adding items to the cart. In a content portal, particular real-world services can include user requests for content such as sports, business, or entertainment news. In a stock trading application, particular real-world services can include operations such as receiving a stock quote, buying, or selling stocks.

An application transaction, in particular, is a representation of the particular service provided by the monitored environment that provides a view on performance data in the context of the various tiers that participate in processing a particular request. That is, an application transaction, which may be identified by a unique application transaction identification (ID), represents the end-to-end processing path used to fulfill a service request in the monitored environment (e.g., adding items to a shopping cart, storing information in a database, purchasing an item online, etc.). Thus, an application transaction is a type of user-initiated action in the monitored environment defined by an entry point and a processing path across application servers, databases, and potentially many other infrastructure components. Each instance of an application transaction is an execution of that transaction in response to a particular user request (e.g., a socket call, illustratively associated with the TCP layer). An application transaction can be created by detecting incoming requests at an entry point and tracking the activity associated with request at the originating tier and across distributed components in the application environment (e.g., associating the application transaction with a 4-tuple of a source IP address, source port, destination IP address, and destination port). A flow map can be generated for an application transaction that shows the touch points for the application transaction in the application environment. In one implementation, a specific tag may be added to packets by application specific agents for identifying application transactions (e.g., a custom header field attached to a hypertext transfer protocol (HTTP) payload by an application agent, or by a network agent when an application makes a remote socket call), such that packets can be examined by network agents to identify the application transaction identifier (ID) (e.g., a Globally Unique Identifier (GUID) or Universally Unique Identifier (UUID)). Performance monitoring can be oriented by application transaction to focus on the performance of the services in the application environment from the perspective of end users. Performance monitoring based on application transactions can provide information on whether a service is available (e.g., users can log in, check out, or view their data), response times for users, and the cause of problems when the problems occur.

In accordance with certain implementations, both self-learned baselines and configurable thresholds may be used to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (or application transaction) or associated infrastructure, such as, e.g., load, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the extensible Markup Language (XML) format). Also, the REST API can be used to query and manipulate the overall observability environment.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be implemented across multiple devices, on different devices, utilizing additional devices, and so on, and the views shown herein are merely simplified examples that are not meant to be limiting to the scope of the present disclosure.

As noted above, nonstandard/custom attributes are not part of the standard telemetry data collected from applications via standard instrumentation. Even if a user wanted to target a specific custom attribute for monitoring, they first must identify relevant files and functions in their application that receive or process these attributes. Then, they must modify the application code to add the custom attributes as part of the telemetry data collected from the application.

This poses multiple problems such as requiring a user to have a deep knowledge of the application code to identify the relevant files and methods which has these custom attributes. This is challenging, since the target users of the telemetry data, people setting up application observability and application developers might be different sets of users/from different groups within an enterprise. Another problem posed by this approach is that, after identifying the file, function, and the custom attribute to collect, the user will have to make application code changes to add the attribute as part of the telemetry data which then will have to be built and redeployed in production. This would require coordination among multiple teams and a lot of turnaround time.

Therefore, the current approach to custom attribute telemetry instrumentation is overly labor-intensive and prone to errors, requiring deep technical knowledge of the application's architecture and significant time investment to identify critical data points for monitoring. This process also lacks scalability and flexibility, making it challenging to adapt to evolving application features and operational goals, thereby hindering efficient performance optimization and strategic decision-making. Furthermore, the necessity for code modifications and coordination among multiple teams for deployment amplifies the risk of disruptions and delays, underscoring the urgent need for an intelligent solution to streamline the telemetry instrumentation process. Therefore, operational blind spots persist in application processes due to the implausible requirement upon users to develop and maintain extensive operational and technical knowledge and skills in order to effectuate custom attribute telemetry. That is, users have a need to collect data relevant to particular enterprise goals from the application performance monitoring (APM) transaction spans but do not have the necessary technical knowledge to instrument the code.

### Generative AI-Assisted Telemetry Instrumentation

In contrast, the techniques described herein empower users with a mechanism to search for relevant custom attributes with the assistance of generative AI. Additionally, it provides users with a mechanism to push the configuration for instrumenting these custom attributes on the APM spans (e.g., OTel Spans).

Illustratively, the techniques described herein may be performed by hardware, software, and/or firmware, such as in accordance with custom telemetry process 248, which may include computer executable instructions executed by the processor 220 (or independent processor of interfaces 210) to perform functions relating to the techniques described herein.

Specifically, according to various implementations, a device may maintain a catalog of attributes that can be collected via a monitoring agent from an application. The device may receive, from a user interface, a prompt for input to a language model that requests collection of a particular type of data from the application. The device may generate, using the language model, a response to the prompt that includes a recommended configuration for the monitoring agent to collect the particular type of data from the application. The device may provide the response to the user interface for display.

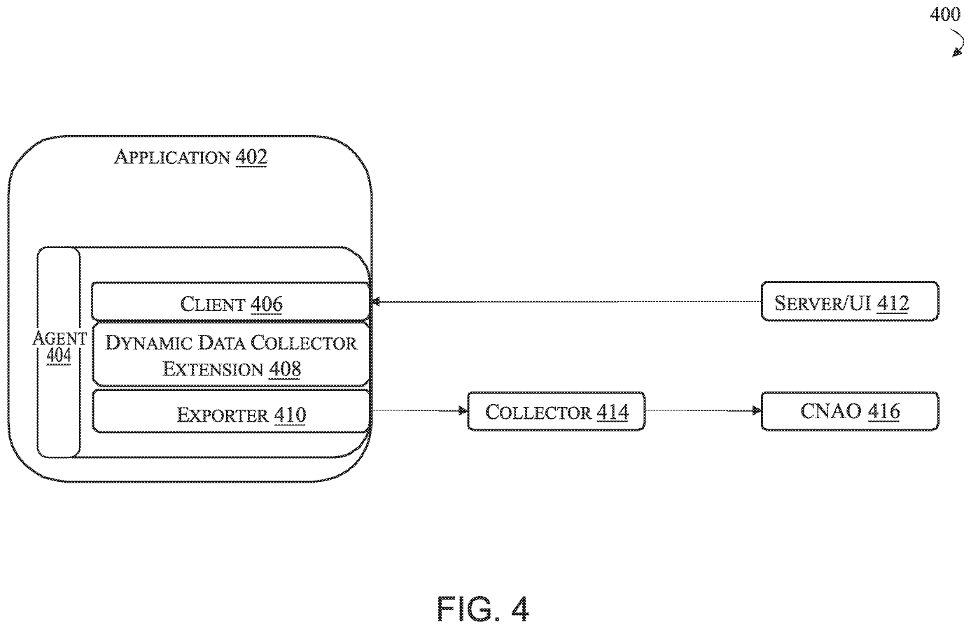

Operationally, FIG. 4 illustrates an example of an architecture 400 for automated custom telemetry instrumentation utilizable with generative AI-assisted telemetry instrumentation. The components of architecture 400 may be operable to achieve remote configuration of an agent 404 (e.g., an OTel agent) to customize attribute collection while avoiding manual code changes, application rebuilds, and redeployments.

Observability frameworks (e.g., OTel) may have specifications for extending their agent capabilities using extensions. Extensions may be utilized to add capabilities to the agent 404 without having to create a separate distribution. For example, extensions may be configured to override or customize the instrumentation provided by the upstream agent without having to create a new distribution (e.g., OpenTelemetry) distribution or alter the code of the agent 404 in any way.

In architecture 400, agent 404 may be configured to define an extension (e.g., dynamic data collector extension 408) that will dynamically add custom instrumentation code to collect custom attributes from the instrumented application (e.g., application 402) based on a configuration.

The configuration (e.g., file name, method name, custom attributes to be collected, etc.) may be passed to the extension using network protocols (e.g., open agent management protocol (OpAMP)) for remote management of data collection agents. Such a protocol may allow agent 404 to report its status to and receive configuration from a server/UI 412 and to receive agent installation package updates from the server/UI 412. The protocol may be vendor-agnostic, so the server/UI 412 can remotely monitor and manage a fleet of different agents that implement the protocol, including a fleet of mixed agents from different vendors.

That is, users may supply a configuration through server/UI 412 (e.g., OpAMP server/UI 412). These configurations may be applied to one or more agents (e.g., OTel agents) such as agent 404. Dynamic custom attribute collector extensions (e.g., dynamic data collector extension 408) in these agents may utilize these configurations to collect the custom attributes specified in the configuration and add them to the telemetry data emitted from the application 402 without manual code change or application redeployment/restart.

For example, in architecture 400 a configuration may be supplied from server/UI 412 to client 406 running in agent 404. For instance, an OpAMP server may send the configuration supplied by a user via the UI to an OpAMP client that is running in an OTel agent. Then, dynamic data collector extension 408 may receive the configuration from the agent 404. The dynamic data collector extension 408 may then apply the custom instrumentations based on the configuration, collect the specified data, and forward it as part of the telemetry data though an exporter 410 component (e.g., an OpenTelemetry Protocol exporter) and/or collector 414 (e.g., OTel collector) to a cloud native application observability (CNAO) backend 416. Therefore, a configuration in the OpAMP UI may be sent to agents and applied without the need to restart any agents and/or pass the configuration through the command line.

It should be appreciated that while some example implementations described herein are discussed in the context of server applications, the principles similarly apply to mobile apps, browser apps, or any other applications where an agent (e.g., OTel agent) is utilized.

Further, while some example implementations are described with respect to adding the collected metrics to spans, this concept may be extended to other mechanisms of metric communication as well. For instance, components of architecture 400 may be utilized to automatically attach attributes as baggage (e.g., OTel baggage). For example, dynamic data collector extension 408 may be leveraged to extract and add the attributes matching invocation calls automatically to the baggage itself.

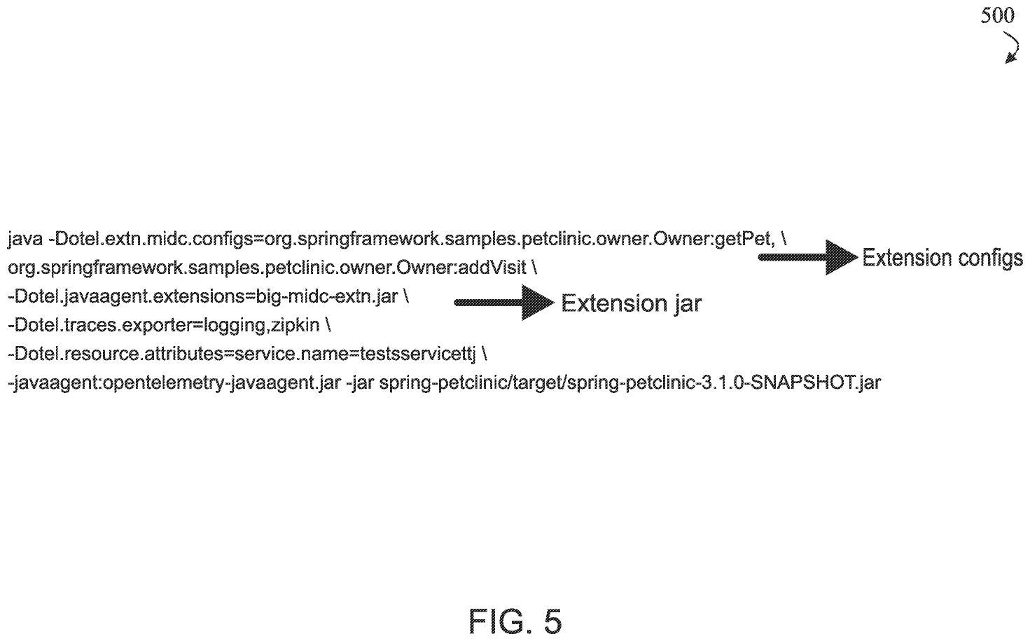

FIG. 5 illustrates an example of a dynamic data collector extension 500 utilizable in generative AI-assisted telemetry instrumentation to dynamically collect user data from instrumented applications. As outlined above, conventional approaches require agents and users to make manual code changes and rebuild and redeploy the application instrumented with the agent to collect user/business data as part of the spans before it can be used for reporting custom metrics in a CNAO. In contrast, dynamic data collector extension 500 may be leveraged to collect additional user/business data from the instrumented application without code changes and report it as span attributes.

In various implementations, a user may specify user data to be collected from the application via a UI. For example, a configuration (which may be completely user generated or specified and/or generated or specified with the assistance of generative AI) may specify a method name, a method signature, a method class, method parameters, match conditions, a specification of data to be collected from a method invocation, a parameter index and/or return value, operations on return values, etc.

For instance, a user may wish to collect additional data from an application associated with a pet clinic. The configuration in such an example may specify a method signature such as a class name “org.springframework,samples.petclinic.owner.Owner” with a method name of “getPet” and specify the user data to be collected from this method invocation. This configuration may be passed to an agent (e.g., OTel agent) instrumented in the application which will dynamically start reporting the new fields/data as part of the spans (e.g., a span attribute of an OTel span).

That is, an agent extension may be created to add custom instrumentation based on user-specified configuration on specific classes/methods. The method configurations may be supplied via a system property (e.g., otel.extn.midc.configs). The dynamic data collector extension 500 (e.g., biq-midc-extension) may apply custom advice on these methods, collect method parameters (e.g., name and values), and/or attach them to the span.

Dynamic data collector extension 500 is a non-limiting example of a Java agent extension that may be utilized in automatically instrumenting custom attribute collection in a Java application instrumented with an OTel agent without requiring code changes. This type of automatic instrumentation may be supported across other languages as well such as .Net (e.g., extending and extracting additional attributes through NuGet packages), Go, Python, etc.

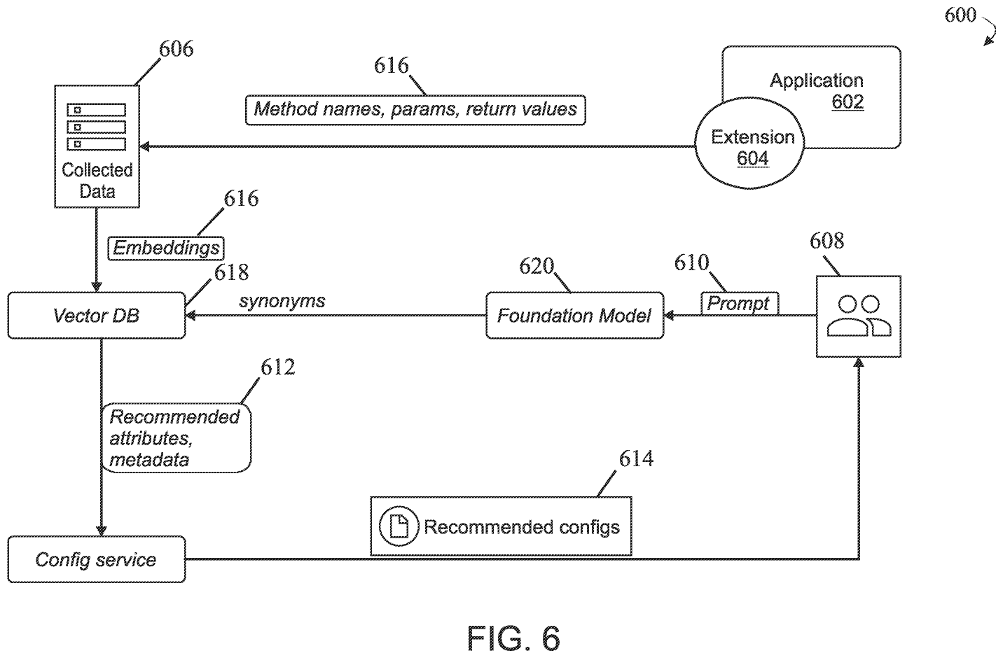

FIG. 6 illustrates an example of an architecture 600 for generative AI-assisted telemetry instrumentation. Some or all of the components of architecture 600 may be utilized to provide non-technical users the ability to add custom configurations. Specifically, extension 604 may be a method invocation data collector utilized to collect sample method parameters, return values from all application files (e.g., may ignore framework/utility/logging/monitoring files and methods) for a period of time, and/or send this data to the observability backend. The collected data 606 can be used to pre-populate the configuration UI in the server (e.g., OpAMP server) for configuring dynamic attribute configuration.

Architecture 600 may be further enhanced by using generative AI to assist with the configuration. For example, the extension 604 (e.g., OTel agent extension) may automatically collect all files, methods, parameter info, function names, return values, etc. 616 from the instrumented application 602 while running. This information may be reported to the backend (e.g., AppD cloud) for a certain configured period of time.

The embeddings 616 for the attribute names may be stored in a data structure (e.g., vector database 618). In addition, a reverse lookup or index that matches the attribute name with the metadata like class name, package name, etc. may also be stored in a reverse index.

Users 608 may state their intent through a prompt 610 to a generative AI interface (e.g., foundation model 620). For example, users 608 may enter a prompt 610 such as “collect total revenue.” Based on processing of the prompt 610, a recommendation 612 may be generated of a relevant file, method, attribute names, etc. from the collected data 606 relevant to the domain and intent shared by the user. For instance, with respect to the prompt 610 to “collect total revenue” the generative AI model may generate “cart total,” “order value,” “quote value,” etc. as the list of possible attribute names.

Matching attribute names from the vector database 618 may be queried against the reverse index to fetch the corresponding metadata. This information may be used to configure the data collector that is part of the extension 604. Users 608 can save this recommended configuration 614, which can then get propagated to the agents via the server/UI (e.g., OpAmp), such as server/UI 412 described with respect to FIG. 4, to start collecting additional attributes as part of the telemetry data.

In addition, the generative AI component may be utilized to provide additional insights and/or suggestions to users 608. For example, the generative AI component may prioritize suggestions based on frequency of occurrence of symbol. For instance, the component may suggest potential data to be collected, potential method call parameters, etc. based on which services they come from and how often those services are called. Since agents may be collecting data regarding how often services are involved, this collected data may be utilized by the generative AI in prioritizing suggested data, method call parameters, etc. This may also be correlated with other domains. For example, the suggestions may be prioritized based on security vulnerabilities and/or security risk scores associated therewith. For instance, if users 608 input a prompt 610 asking for “revenue at risk” data, method parameters, etc. determined by the model to be associated with revenue may be prioritized within the suggestion according to their corresponding security risk scores.

Furthermore, the generative AI component may be utilized to suggest recommendations based on selected attributes. For example, a selected and/or recommended attribute could be used to suggest recommendations for other attributes like city, zip code, etc. These suggestions may be utilized in populating additional configurations as well.

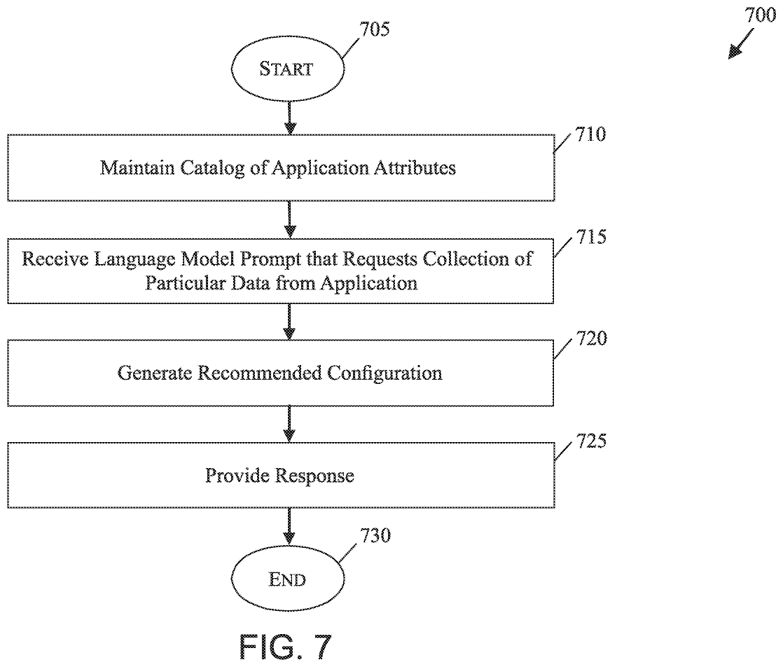

FIG. 7 illustrates an example of a simplified procedure for generative AI-assisted telemetry instrumentation, in accordance with one or more implementations described herein. For example, a non-generic, specifically configured device (e.g., device 200), may perform procedure 700 (e.g., a method) by executing stored instructions (e.g., custom telemetry process 248). The procedure 700 may start at step 705, and continues to step 710, where, as described in greater detail above, the device (e.g., a controller, processor, etc.) may maintain a catalog of attributes that can be collected via a monitoring agent from an application.

Maintaining the catalog of attributes includes storing representations the attributes along with a reverse index that associates each representation of an attribute with corresponding metadata for configuring the monitoring agent to collect a corresponding type of data. The corresponding metadata of an attribute may include a file name, a method name, an attribute name, and/or a function return value associated with the attribute.

At step 715, as detailed above, the device may receive, from a user interface, a prompt for input to a language model that requests collection of a particular type of data from the application. For example, a prompt may include a request to the language model that specifies a name, type, or characterization of an attribute that they desire to be tracked at the application and/or added to a tracing span.

At step 720, the device may generate, using the language model, a response to the prompt that includes a recommended configuration for the monitoring agent to collect the particular type of data from the application. The recommended configuration may define an extension configuration to customize data collection by the monitoring agent such that it includes collection of the particular type of data without altering the code of the monitoring agent. In some implementations, the recommended configuration may cause the particular type of data collected from the application to be added to a tracing span.

Generating the response to the prompt may include identifying attributes within the catalog of attributes that correspond to the particular type of data (e.g., match attribute names associated with the particular type of data) specified in the prompt. The recommended configuration may be generated based on metadata associated with the attributes within the catalog of attributes that correspond to the particular type of data specified in the prompt. That is the recommended configuration may include metadata associated with attributes within the catalog that have attribute names that match attribute names specified within and/or associated with the intent of prompt.

In various implementations, the device may generate a recommended configuration for the monitoring agent to collect an additional type of data based on a relationship of the additional type of data to the particular type of data. That is, a recommended configuration for collecting data other that the particular type of data specified in the prompt may be suggested based on the data being related to the particular type of data. For instance, a selected and/or recommended attribute related to a state associated with a transaction could be used to suggest recommendations for other attributes like city, zip code, etc. associated with the transaction.

At step 725, as detailed above, the device may provide the response to the user interface for display. In addition, the recommended configuration may be provided to a control plane associated with the monitoring agent to propagate the recommended configuration to the monitoring agent. This may, in some instance, include utilizing the recommended configuration to auto-populate a configuration interface of an OpAMP control plane for configuring dynamic attribute collection.

In some instances, the device may prioritize configurations for recommendation and/or their display based on a frequency of corresponding data collected at the application. For example, a device may prioritize configuration recommendations based on which services they come from and how often those services are called.

Procedure 700 then ends at step 730.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

The techniques described herein, therefore, empower users with a mechanism to search for relevant custom attributes with the assistance of generative AI. Additionally, it provides users with a mechanism to push the configuration for instrumenting these custom attributes on the APM spans (e.g., OTel Spans). This transformative approach to telemetry instrumentation by leveraging generative AI and the automated instrumentation of customized telemetry collection advances telemetry configuration beyond the highly technical manual approach involving significant investments of time and resources in rebuilding, redeploying, and/or restarting existing telemetry collection and into a future where customization of telemetry is accessible to users across technical proficiencies in a manner that does not disrupt the existing telemetry collection lifecycle. In addition to the performance improvements offered by the ability to persist telemetry collection while rapidly deploying customizations thereof, the democratization of application monitoring and optimization allows for rapid and dynamic enhancements to efficiency, accuracy, problem identification and resolution, process improvements, etc. for an application and/or process across all facets of an enterprise.

While there have been shown and described illustrative implementations that provide for generative AI-assisted telemetry instrumentation, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method, comprising:
maintaining, by a device, a catalog of attributes that can be collected via a monitoring agent from an application;
receiving, at the device and from a user interface, a prompt for input to a language model that requests collection of a particular type of data from the application;
generating, by the device and using the language model, a response to the prompt that includes a recommended configuration for the monitoring agent to collect the particular type of data from the application; and
providing, by the device, the response to the user interface for display.

2. The method as in claim 1, wherein maintaining the catalog of attributes comprises:
storing representations of the attributes along with a reverse index that associates each representation with corresponding metadata for configuring the monitoring agent to collect a corresponding type of data.

3. The method as in claim 2, wherein the corresponding metadata of an attribute includes one or more of: a file name, a method name, an attribute name, or a function return value associated with the attribute.

4. The method as in claim 1, wherein the recommended configuration defines an extension configuration to customize data collection by the monitoring agent to include collection of the particular type of data without altering code of the monitoring agent.

5. The method as in claim 1, wherein generating the response to the prompt comprises:
identifying attributes within the catalog of attributes that correspond to the particular type of data specified in the prompt.

6. The method as in claim 5, further comprising:
generating the recommended configuration based on metadata associated with the attributes within the catalog of attributes that correspond to the particular type of data specified in the prompt.

7. The method as in claim 1, further comprising:
generating a recommended configuration for the monitoring agent to collect an additional type of data based on a relationship of the additional type of data to the particular type of data.

8. The method as in claim 1, further comprising:
prioritizing configurations for recommendation based on a frequency of corresponding data collected at the application.

9. The method as in claim 1, further comprising:
providing the recommended configuration to a control plane associated with the monitoring agent to propagate the recommended configuration to the monitoring agent.

10. The method as in claim 1, wherein the recommended configuration causes the particular type of data collected from the application to be added to a tracing span.

11. An apparatus, comprising:
one or more network interfaces;
a processor coupled to the one or more network interfaces and configured to execute one or more processes; and
a memory configured to store a process that is executable by the processor, the process when executed configured to:
maintain a catalog of attributes that can be collected via a monitoring agent from an application;
receive, from a user interface, a prompt for input to a language model that requests collection of a particular type of data from the application;
generate, using the language model, a response to the prompt that includes a recommended configuration for the monitoring agent to collect the particular type of data from the application; and
provide the response to the user interface for display.

12. The apparatus as in claim 11, wherein the apparatus maintains the catalog of attributes by:
storing representations of the attributes along with a reverse index that associates each representation with corresponding metadata for configuring the monitoring agent to collect a corresponding type of data.

13. The apparatus as in claim 12, wherein the corresponding metadata of an attribute includes one or more of: a file name, a method name, an attribute name, or a function return value associated with the attribute.

14. The apparatus as in claim 11, wherein the recommended configuration defines an extension configuration to customize data collection by the monitoring agent to include collection of the particular type of data without altering code of the monitoring agent.

15. The apparatus as in claim 11, wherein the apparatus generates the response to the prompt by:
identifying attributes within the catalog of attributes that correspond to the particular type of data specified in the prompt.

16. The apparatus as in claim 15, wherein the process when executed is further configured to:
generate the recommended configuration based on metadata associated with the attributes within the catalog of attributes that correspond to the particular type of data specified in the prompt.

17. The apparatus as in claim 11, wherein the process when executed is further configured to:
generate a recommended configuration for the monitoring agent to collect an additional type of data based on a relationship of the additional type of data to the particular type of data.

18. The apparatus as in claim 11, wherein the process when executed is further configured to:
prioritize configurations for recommendation based on a frequency of corresponding data collected at the application.

19. The apparatus as in claim 11, wherein the process when executed is further configured to:
provide the recommended configuration to a control plane associated with the monitoring agent to propagate the recommended configuration to the monitoring agent.

20. A tangible, non-transitory, computer-readable medium storing program instructions that cause a device to execute a process comprising:
maintaining a catalog of attributes that can be collected via a monitoring agent from an application;
receiving, from a user interface, a prompt for input to a language model that requests collection of a particular type of data from the application;
generating, using the language model, a response to the prompt that includes a recommended configuration for the monitoring agent to collect the particular type of data from the application; and
providing the response to the user interface for display.
